(19) United States
(12) Patent Application Publication
(10) Pub. No.: US 2020/0239333 A1
(43) Pub. Date: Jul. 30, 2020

(54) System, Method, and Apparatus for Reducing Harmful Microorganisms from a Body of Water

(71) Applicant: Magnegas IP, LLC, Clearwater, FL (US)

(72) Inventors: Ermanno Santilli, St. Petersburg, FL (US); Richard Conz, Seminole, FL (US)

(73) Assignee: Magnegas IP, LLC, Clearwater, FL (US)

(21) Appl. No.: 16/774,072

(22) Filed: Jan. 28, 2020

Related U.S. Application Data
(60) Provisional application No. 62/798,219, filed on Jan. 29, 2019.

(51) Int. Cl. C02F 1/30; C02F 1/467; C02F 1/46; C02F 103/00

(52) U.S. Cl. CPC C02F 1/30; C02F 1/4672; C02F 2303/04; C02F 2103/007; C02F 1/4608

(57) ABSTRACT

A method of processing water contaminated with harmful microorganisms is disclosed including drawing in a fluid that is contaminated with microorganisms from a depth of a body of the water and passing the fluid through a submerged arc to reduce populations of harmful microorganisms as well as reduce nutrient concentrations in the fluid. After flowing through the arc, the fluid is cooled before returning the fluid to the body of water.

### CROSS-REFERENCE TO RELATED APPLICATION

This application claims the benefit of U.S. provisional application No. 62/798,219 filed on Jan. 29, 2019, the disclosure of which is incorporated by reference.

### FIELD

This invention relates to the field of water processing and more particularly to a system for reducing the presence of certain biology and reducing available nutrients, thereby reducing reproduction of certain harmful microorganisms in the water.

### BACKGROUND

In the past decades, several bodies of water have been severely affected by an excessive growth of certain biological life forms. For example, in 2018, an estimated 90% of Lake Okeechobee in Florida was covered in toxic algae (green algae). It has been suggested that runoff from suburban lawns, leaky septic tanks, farms, and golf courses flow from the north into the lake. Runoff drains into the Kissimmee River which flows into Lake Okeechobee. Further, water from cane fields south of Lake Okeechobee is directed into the lake during periods of heavy rain to keep fields and towns from flooding. This runoff increases the amount of phosphorus in the lake and thereby increases phosphorus that flows with the water, reaching the Atlantic Ocean and the Gulf of Mexico. This phosphorus nourishes plumes of toxic algae in the lake, in the Atlantic Ocean and in the Gulf of Mexico. The toxic algae drive off or kill fish, kill oyster beds, they endanger the health of people living nearby, and they damage the local economy. During periods of heavy rain, the lake water, laced with phosphorus and algae, is discharged into the St. Lucie and Caloosahatchee rivers and eventually into the sea.

As the nutrient-rich water having high levels of Cyanobacteria flows through rivers to the sea, levels of nutrients in the sea go up. Further, when the Cyanobacteria are exposed to salt water, the Cyanobacteria die, possibly releasing more nutrients into the sea. The nutrient rich sea water, especially during warm weather, creates a high-growth area for other toxic organisms such as Red Tide, or Karenia brevis. Red Tide is an algae bloom in which an area of water has large concentrations of microorganisms such as protozoans or unicellular algae such as dinoflagellates and diatoms.

Red Tide, or Karenia brevis, normally occurs in many bodies of water, especially warm water such as in the Caribbean Sea, Gulf of Mexico, and southern Atlantic. Normally, Red Tide is in low concentrations and does not significantly impact other life forms in those bodies of water. Unfortunately, there have been several outbreaks of substantial concentrations of Red Tide along the shores of Florida that were so severe that fish, sea turtles, manatees, sharks, dolphins, and even whales have been found dead, floating in the waters or washed upon the beaches. Following this, birds having eaten these dead animals have suffered as well. Red Tide produces brevotoxins that kill fish and other animals by affecting the nervous system.

Further, the Red Tide algae cells can break open due to wave action, releasing toxins into the air, creating health problems that lead to coughing, sneezing, and tearing. The health problems can cause problems to people with chronic respiratory conditions and government health agencies often warn people with such respiratory conditions to avoid areas polluted with such toxins, which is difficult for those who live on the beaches and waterways.

The economic pain inflicted by Red Tide is overwhelming. The simplest economic impact is the costs to coastal communities for clean-up of the tons of wildlife left dead on the beaches. In August, 2018, the governor of Florida made $3,000,000 available for cleanup. In 2018, after Sep. 7, 324 tons of dead marine life was hauled away from Pinellas County Fla. Florida spent around $13M in the last half of 2018 for cleanup.

Harder to determine is the economic impact to restaurants, hotels, and other recreational service companies both along the beaches and distances away (e.g. travel agencies, airlines). As the Red Tide bloom increases, the toxic gases released by the Red Tide, along with the smell and sight of rotting fish and other wild life deter tourism, leading to empty restaurants, empty hotels, empty fishing boats, empty airplanes, etc. During the Red Tide bloom of 2018, several restaurants closed, resulting in employees being let go. In Sarasota Fla., almost 50% of the businesses reported a downturn in business of at least 50% compared to the prior year. In another report, it was estimated that, 76 percent of businesses surveyed lost $500,000 or more. Not included is the trickle up costs, for example, due to unemployed workers with lower spending ability and less need for restaurant supplies (e.g. paper goods, vegetables, meat, grain).

Hospitals experienced increases in diagnoses of pneumonia, gastrointestinal illness, and respiratory illness. The costs associated with increased health care alone in Sarasota county Fla. were estimated to be between 0.5 and 4 million dollars.

The economic impact alone is incredible, but it is such an inhumane way for so many animals to die. Even though algae blooms have occurred at least going back to early settlers, the extent of recent blooms and the damage and economic impact is immense.

Some attempts to reduce algae in lakes include chemical treatment, similar to algaecides used for swimming pools and spas. Many such chemicals are copper-based. One such material includes Copper Triethanolamine Complex which may be harmful if inhaled and is slightly toxic if swallowed. This material is not recommended for use where Koi, Trout, or Channel Catfish are present as these species of fish are more sensitive to copper or copper sulfate based products.

Some compounds are designed to reduce phosphates in the water, thereby reducing nutrients available to the algae. The material safety data sheet for on such material for reducing phosphates indicates the material is made from aluminum sulphate. Note that ingestion of this material (according to the MSDS) causes nausea, vomiting, stomach cramps, diarrhea in small quantities and ulcerations and necrosis of the mucous membranes in the throat and mouth and esophagi, liver and kidney damage, hemorrhagic gastroenteritis and intense thirst in large quantities. Frequent or prolonged contact may cause dermatitis.

Some have developed water treatments that include the use of ozone (O₃). Unfortunately, ozone is highly reactive and a powerful oxidizing agent. When exposed to non-saturated organic compounds, ozone produces ozonides which are unstable and explosive. Ozone is a mouth and eye irritant.

To make matters worse, different biological life forms concentrate at different depths of water. For example, Cyanobacteria obtain their energy through photosynthesis and, therefore, are present in the upper regions of a body of water (e.g. within a depth of one meter) while does not require sunlight and is present in depths where nutrients are found.

What is needed is a system that will properly manage harmful biological life forms, reducing bad microorganisms and allowing growth of good microorganisms.

### SUMMARY

In one embodiment, a system is disclosed including a sterilization device that decreases biological components from a body of water while also reducing nutrients, thereby reducing regrowth of the biology.

A method of processing water from a body of water is disclosed including subjecting the water to plasma of a submerged arc, thereby reducing the number of harmful microorganisms in the water and reducing the amount of nutrients remaining in the water, thereby reducing regrowth of harmful microorganisms.

In one embodiment, a method of processing water contaminated with harmful microorganisms is disclosed including drawing in a fluid that is contaminated with microorganisms from a depth of a body of the water and passing the fluid through a submerged arc. After flowing through the plasma of the submerged arc, the fluid is cooled before returning the fluid to the body of water.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of an exemplary system for the reducing harmful organisms and nutrients in a body of water.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Dealing with microorganisms in a body of water is a challenge, due to the fast growth of harmful, bad microorganisms within a nutrient-rich body of water. The following description describes a system and method for processing water from a body of water to reduce the harmful, bad microorganisms while also reducing a supply of nutrients that is available in the body of water, thereby impeding regrowth of the harmful, bad microorganisms.

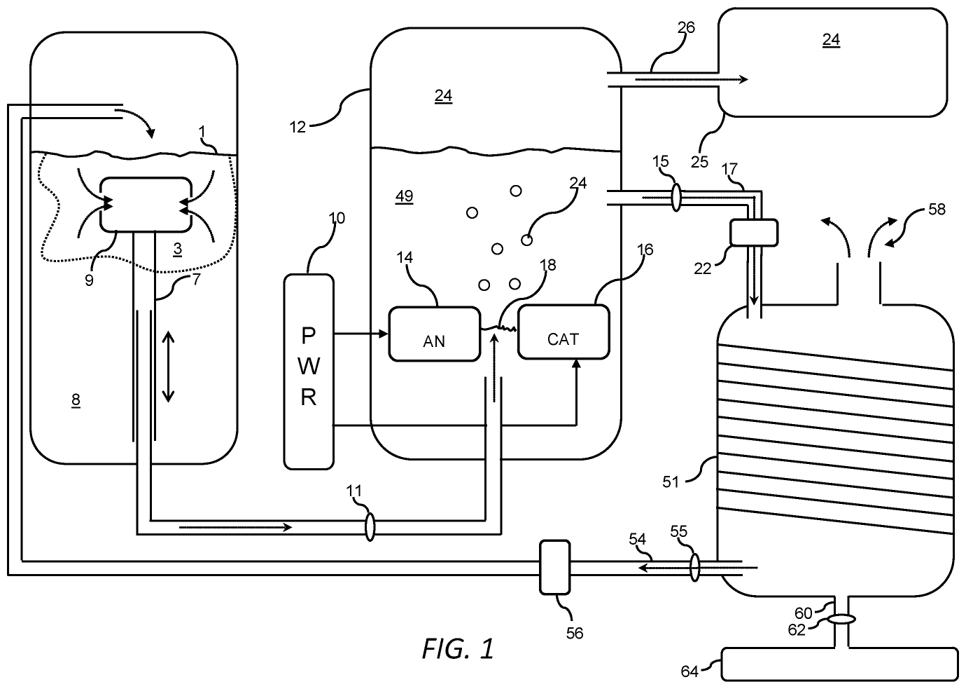

Referring to FIG. 1, an exemplary system for the reducing harmful organisms and nutrients in a body of water is shown. This is but an example of one system for the processing of water from a lake, sea, ocean, etc., as other such systems are also anticipated. As shown, water including harmful organisms and nutrients if flown from the body of water through a reactor where at least some of the harmful organisms are destroyed and the nutrients are reduced. Such a reactor is discussed in, for example, U.S. Pat. No. 7,780,924 issued Aug. 24, 2010, U.S. Pat. No. 6,183,604 issued Feb. 6, 2001, U.S. Pat. No. 6,540,966 issued Apr. 1, 2003, U.S. Pat. No. 6,972,118 issued Dec. 6, 2005, U.S. Pat. No. 6,673,322 issued Jan. 6, 2004, U.S. Pat. No. 6,663,752 issued Dec. 16, 2003, U.S. Pat. No. 6,926,872 issued Aug. 9, 2005, and U.S. Pat. No. 8,236,150 issued Aug. 7, 2012, all of which are incorporated by reference.

In the system for the reducing harmful organisms and nutrients in a body of water, reduction of harmful organisms and reduction of nutrients is performed within the plasma 18 of a submerged electric arc, preferably without introducing any harmful chemicals. The plasma 18 of a submerged arc also destroys toxins that are created by the harmful microorganisms.

In the example shown, there is a body of water 8 that is contaminated (shown in simplified form for clarity and brevity reasons) such as a lake, stream, pond, ocean, or bay. An algae bloom 3 is shown in the body of water 8. The algae bloom 3 is contaminated with some form of microorganism such as Cyanobacteria and/or Karenia brevis. The contaminated water is pumped from a filter 9 positioned in the body of water 8 near/in the algae bloom 3 and into a reactor 12 by an input pump 11. In some embodiments, the level of submersion of the input filter 9 is adjustable to accommodate different types of microorganisms that are present at different depths of the body of water 8. The contaminated water is drawn in through the filter 9 to prevent marine animals such as small fish, small crabs, and small shrimp from being pulled in along with the contaminated water. The filter 9 also prevents debris from entering the reactor (e.g. twigs, leaves). In some embodiments, the flow of the contaminated water is controlled with respect to an area of the openings in the filter 9 so as to prevent objects such as debris or small animal life from being held against the filter 9.

In some embodiments the filter 9 telescopes by way of a telescoping mechanism 7 to adjust the water level from which the contaminated water is drawn from the body of water 8. For example, when treating water contaminated with Cyanobacteria, the contaminated water is drawn from a shallow depth of, for example, less than one meter from the surface 1 of the body of water 8, as Cyanobacteria require sunlight for energy and, therefore, live relatively close to the surface 1 of the body of water 8. In another example, when treating water contaminated with , the contaminated water is drawn from various depths, as does not require sunlight and, therefore, live at many depths of the driven by a motor 4 and the filter 9 is moved up and down continuously to draw contaminated water from multiple depths by the motor 4. In some embodiments, the filter 9 floats, collecting water from the surface 1 of the body of water 8 (e.g. skimming), which is effective for Cyanobacteria that form a green slime on the surface 1 of the body of water 8.

The contaminated water flows into plasma 18, for example, plasma 18 created by a submerged arc struck between two electrodes 14/16 (submerged within a fluid 49 which contains the contaminated water from the body of water 8). When the contaminated water is exposed to the plasma 18, a substantial number of the microorganisms are killed. Further, it has been demonstrated that when nutrients (e.g. phosphorous, nitrogen, and potassium) are exposed to the plasma 18, the amount of nutrients is also reduced by the plasma 18. Measurements have shown that nutrient content of the fluid 49 are reduced by approximately 40% after exposure to the plasma 18 of a submerged arc. It has also been demonstrated that after exposure of a fluid to the plasma 18 of a submerged arc, certain unwanted compounds are dismantled such as pharmaceuticals, leachates, and PCBs.

In some embodiments, the fluid 49 is circulated within the reactor 12 and back through the plasma 18 to further reduce presence of microorganisms and reduce the amount of nutrients available in the fluid.

In some embodiments, the submerged arc is powered by a source of electric power 10 including any power source such as the power grid, a generator (for remote locations), solar power, power from batteries, etc.

As a bi-product of the contaminated water flowing through the plasma 18, a gas 24 is released, percolating to the top of the fluid 49. In some embodiments, the gas 24 collects above the fluid 49 and is extracted through plumbing 26 into a gas holding tank 25. It is anticipated that, in some embodiments, the gas 24 be used to provide some of the power needed for running the submerged arc and/or for power to assist in cooling the fluid. In some embodiments, the gas 24 is stored and transported for use in welding/cutting metals, etc.

The fluid 49 leaving the reactor 12 is water having less microorganisms and less nutrients. In some embodiments, especially those in which the fluid 49 is recirculated through the submerged arc, the fluid 49 is practically void of microorganisms.

After the reduction of microorganisms and nutrients by the submerged arc, in some embodiments, the fluid 49 (which has been heated by the submerged arc) is pumped into a cooling system 51 (e.g. waterfall system, air cooled system, sprinkler, drip system with fans) through intermediate plumbing 17 by an intermediate pump 15. In some embodiments, an intermediate filter 22 removes certain particulate matter in the fluid 49. The intermediate filter 22 is, for example, a sand filter, an activated charcoal and sand filter, a diatomaceous earth filter, a combination of any of the prior, etc.

In some embodiments of the cooling system 51, the fluid 49 is oxygenated as there is a loss of oxygen due to the plasma 18. The fluid 49 is cooled so as to not substantially increase the average temperature of the body of water 8, as it is known that certain unwanted microorganisms thrive in warmer water. It is anticipated that some of the fluid 49 will evaporate as water vapor/steam 58.

In some embodiments, solids are collected (either before cooling or after cooling). In some such embodiments, the solids are used for power generation or fertilizer. In such, there is a separator to separate the solids from the fluid 49 before the fluid is returned into the body of water 8. In the example shown in FIG. 1 includes a gravity separation in which solids accumulate at the bottom of the cooling system 51 (bottom may be shaped with a slope) with an opening connected to a separation conduit 60 that routes the solids to a solids holding tank 64 for later extraction and use. In some embodiments, a separation valve 62 is opened or closed to control collection of solids.

After the fluid 49 cools (e.g. water with reduced harmful microorganisms and reduced nutrients), the fluid 49 is pumped by a return pump 55 through plumbing 54 and returned back into the body of water 8.

In some embodiments, a post-cooling filter 56 removes certain particulate matter in the fluid 49. The post-cooling filter 56 is, for example, a sand filter, an activated charcoal and sand filter, a diatomaceous earth filter, a combination of any of the prior, etc.

Being that there a less of the harmful microorganisms and less nutrients, the overall health of the body of water 8 increases with the introduction of an amount of the fluid absent of microorganisms.

Although the system for the reducing harmful organisms and nutrients is disclosed as passing the contaminated water through plasma 18 created by an electric arc between two electrodes 14/18, any source of the plasma is fully anticipated.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of processing water contaminated with harmful microorganisms, the method comprising:
drawing in a fluid that is contaminated with microorganisms from a depth of a body of the water;
flowing the fluid through a plasma of a submerged arc;
cooling the fluid; and
returning the fluid to the body of water.

2. The method of claim 1, wherein the microorganisms comprise Cyanobacteria.

3. The method of claim 2, wherein the depth is less than one meter from a surface of the body of water.

4. The method of claim 1, wherein the microorganisms comprise Karenia brevis.

5. The method of claim 4, wherein the depth is varied during the step of drawing in the fluid.

6. The method of claim 1, wherein the depth is settable.

7. The method of claim 1, further comprising adjusting the depth with a motorized telescoping mechanism.

8. The method of claim 7, further comprising continuously varying the depth using the motorized telescoping mechanism.

9. A system for processing water in a body of water that is contaminated with harmful microorganisms, the system comprising:
an input port coupled to the body of the water;
a pump, an input of the pump fluidly coupled to the input and an output of the pump fluidly coupled to a reactor;
the fluid flowing through a plasma of an electric arc drawn between two electrodes for killing at least some of the microorganisms; and
a second pump, a second pump input fluidly coupled to the reactor and a second pump output fluidly coupled to the body of water for returning the fluid to the body of water.

10. The system of claim 9, wherein a cooling device is fluidly inserted between the reactor and the second pump or between the second pump and the body of water for cooling the fluid before returning the fluid to the body of water.

11. The system of claim 9, wherein the input port comprises a filter.

12. The system of claim 11, wherein the filter is fluidly coupled to the pump through a telescoping system, thereby allowing for adjustment of a depth of the filter.

13. The system of claim 12, wherein the telescoping system is controlled by a motor.

14. The system of claim 9, further comprising a collection tank fluidly coupled to the reactor for collecting a gas generated by the plasma.

15. The system of claim 9, further comprising a solids collection system including a solids holding tank for collecting solids from the fluid by gravity.

16. A method of processing water contaminated with harmful microorganisms, the method comprising:
drawing in a fluid that is contaminated with microorganisms through a filter from a depth of a body of the water;
flowing the fluid through a plasma of a submerged arc; and
returning the fluid to the body of water.

17. The method of claim 16, further comprising cooling the fluid before the step of returning the fluid to the body of water.

18. The method of claim 16, wherein the depth is varied during the step of drawing in the fluid.

19. The method of claim 16, further comprising adjusting the depth with a motorized telescoping mechanism.

20. The method of claim 19, further comprising continuously varying the depth using the motorized telescoping mechanism.
